(19) United States
(12) Patent Application Publication
(10) Pub. No.: US 2024/0253547 A1
(43) Pub. Date: Aug. 1, 2024

(54) LOCKING DEVICE FOR A VEHICLE SEAT, ADAPTER ARRANGEMENT FOR ATTACHMENT OF A LOCKING DEVICE, AND VEHICLE SEAT

(71) Applicant: Adient US LLC, Plymouth, MI (US)

(72) Inventors: Peter MUELLER, Mackenbach (DE); Daniel POLLÁK, Trencín (SK)

(73) Assignee: Adient US LLC, Plymouth, MI (US)

(21) Appl. No.: 18/419,680

(22) Filed: Jan. 23, 2024

(30) Foreign Application Priority Data
Jan. 30, 2023 (DE) 10 2023 102 186.9
Dec. 13, 2023 (DE) 10 2023 134 965.1

(51) Int. Cl. B60N 2/90; B60N 2/20

(52) U.S. Cl. CPC B60N 2/933; B60N 2/20

(57) ABSTRACT

A locking unit for a vehicle seat may have a housing and a locking device, arranged at least partially in the housing, for detachably locking a mating element. The locking device may have a baseplate, a first bearing bolt, a second bearing bolt, a rotary latch with a receptacle for securing the mating element and at least one securing element for securing a closed position of the rotary latch. The at least one securing element is pivotably mounted on the second bearing bolt. The housing may have a first housing part with a bottom, and a second housing part with a bottom. The bottom of the first housing part has at least one projection, which is formed in the direction of the rotary latch and/or the at least one securing element. An adapter arrangement for attachment of the locking unit to a vehicle seat is also provided.

### FIELD

The invention relates to a locking unit for a vehicle seat, comprising a housing and a locking device, arranged at least partially in the housing, for detachably locking a mating element, to an adapter arrangement for attachment of such a locking device in particular to a vehicle seat, and to a vehicle seat.

### BACKGROUND

WO 2004/069580 A2 discloses a locking device for a vehicle seat having an open housing, a pawl, pivotably mounted on the housing, to be locked with a mating element, and at least one securing element which is also pivotably mounted on the housing and secures a locked state by interacting with the pawl. The locking device can be mounted on a structural part of the vehicle seat, wherein the structural part forms the cover for substantially closing the housing. A downwardly open receptacle which serves to receive the mating element fixed to the vehicle structure is formed in a lower region of the housing. The width of the receptacle is greater than the diameter of the mating element for tolerance compensation. The mating element may be a bolt or a portion of a bracket.

WO 2010/003586 A1 discloses a locking device for a vehicle seat, the locking device comprising a pawl, mounted pivotably about a first bearing bolt, to be locked to a mating element, and two securing elements which secure the pawl in the locked state. The securing elements are mounted pivotably about a second bearing bolt, which is arranged parallel to the first bearing bolt. The locking device has a half-open lock housing with a basic area and upstanding edges. The pawl and the securing elements are arranged in the lock housing. The lock housing is substantially closed by a lock cover. The lock housing and the lock cover form a receptacle which is open in the direction of a mating element, in order to receive the latter for locking purposes. The locking device also has an unlocking housing and an unlocking handle arranged therein for pivoting the securing elements and thus unlocking the locking device. The unlocking housing is formed separately from the lock housing and the lock cover and fastened to the upper end of the lock housing and the lock cover. The separate form of the lock housing and the unlocking housing makes it possible to adapt the materials to the respective requirements, in particular in terms of the strength requirements.

WO 2016/079041 A1 discloses a locking device, in particular for locking a backrest of a vehicle seat to a vehicle structure, having a rotary latch lock for locking a mating element, wherein the locking device comprises an ejection lever, which displaces the mating element relative to the rotary latch lock by actuation of an operating handle in an unlocked state of the rotary latch lock.

WO 2016/156178 A1 discloses an adapter arrangement for a vehicle seat for attachment of a locking device to a structural component of the vehicle seat. The locking device has a housing, in which a rotary latch and a latching pawl are arranged. The housing comprises a first side plate and a second side plate. The first side plate and the second side plate each have a slot-shaped receptacle which is open in the direction of a mating element, in order to be able to receive the latter for locking by the rotary latch. The adapter arrangement supports the housing in two opposite directions, as a result of which the locking device is reinforced, in particular in and counter to a transverse direction. The adapter arrangement according to the invention enables a higher load-bearing capacity of the locking device by supporting the housing on the adapter arrangement. Moreover, a rotary latch and/or a latching pawl can be supported on the adapter arrangement with the housing situated in between. This increases the load-bearing capacity of the locking device, in particular in the event of lateral loads. The risk of the rotary latch and the latching pawl laterally buckling is reduced.

### SUMMARY

The problem addressed by the invention is to improve a locking device of the type mentioned in the introduction. The locking device should be lightweight and inexpensive but still have a high strength, in particular in and counter to a transverse direction. The intention is also to provide a vehicle seat having a locking device according to the invention, wherein the seat structure in combination with a locking device according to the invention should have a high strength, in particular in and counter to a transverse direction.

This problem is solved according to the invention by a locking unit for a vehicle seat, comprising a housing and a locking device, arranged at least partially in the housing, for detachably locking a mating element, the locking device comprising a baseplate; a first bearing bolt, wherein the first bearing bolt, in particular exactly one end region of the first bearing bolt, is fixedly connected to the baseplate; a second bearing bolt, wherein the second bearing bolt, in particular exactly one end region of the second bearing bolt, is fixedly connected to the baseplate; a rotary latch with a receptacle for securing the mating element, wherein the rotary latch is pivotably mounted on the first bearing bolt; at least one securing element for securing a closed position of the rotary latch, wherein the at least one securing element is pivotably mounted on the second bearing bolt, the housing comprising a first housing part with a bottom, and a second housing part with a bottom, wherein the locking device is arranged axially between the bottom of the first housing part and the bottom of the second housing part; the rotary latch and the at least one securing element are arranged axially between the baseplate and the bottom of the first housing part, and the bottom of the first housing part has at least one projection, which is formed in the direction of the rotary latch and/or the at least one securing element.

The mating element may for example be a bolt, a bracket or a bent wire. The locking element serves to detachably lock a component, which is movable in an unlocked state of the locking unit, of the vehicle seat to another component of the vehicle seat or to a vehicle component, in particular a body component.

The locking unit may be fixedly connected to a component, which is movable in an unlocked state of the locking unit, of the vehicle seat, wherein the mating element is then preferably fixedly connected to another component of the vehicle seat or to a vehicle component, in particular a body component. As an alternative, the locking unit may be fixedly connected to a vehicle component, in particular a body component, such as a rear shelf or a vehicle floor, wherein the mating element is then preferably fixedly connected to a component, which is movable in an unlocked state of the locking unit, of the vehicle seat.

A smallest distance between the projection of the first housing part and the rotary latch may correspond to a smallest distance between the first housing part and the rotary lock.

A smallest distance between the projection of the first housing part and the at least one securing element may correspond to a smallest distance between the first housing part and the at least one securing element.

The first bearing bolt may have an axial securing device for axially securing the rotary latch on the first bearing bolt in at least one axial direction. The bottom of the first housing part may directly abut the axial securing device of the first bearing bolt.

The second bearing bolt may have an axial securing device for axially securing the at least one securing element on the second bearing bolt in at least one axial direction. The bottom of the first housing part may directly abut the axial securing device.

The locking unit may have an actuating device for unlocking the locking device. The actuating device may have an operating element and a coupling part for coupling the operating element to the locking device. The actuating device may have an operating element and a coupling part for coupling the operating element to the at least one securing element of the locking device. The coupling part may be a wire. The coupling part may be at least partially arranged between, on the one hand, the rotary latch and/or the at least one securing element and, on the other hand, the housing, in particular the bottom of the first housing part.

The bottom of the first housing part may have at least one further projection, which is formed on a side of the bottom that faces away from the rotary latch. The bottom of the first housing part may have at least two, preferably exactly three, projections, which are formed on a side of the bottom that faces away from the rotary latch. The at least two projections may be spaced from one another. The at least two projections may each run parallel to one another. An end stop for the mating element may be integrated in the housing.

The first bearing bolt and/or the second bearing bolt may have an internal thread for fastening the locking unit to an adapter arrangement. The first bearing bolt may be connected to the second bearing bolt by a closure plate. The closure plate may be arranged axially between the rotary latch and the first housing part.

The problem is also solved by an adapter arrangement for attachment of a locking device according to the invention to a vehicle seat, the adapter arrangement having a first adapter part and a second adapter part, between which the locking device can be arranged and laterally supported, in particular in and counter to a transverse direction. The adapter arrangement is preferably fixedly connected, in particular welded, to a seat structure of the vehicle seat.

An end stop of the housing for the mating element may be supportable on the first adapter part and/or on the second adapter part. Such an adapter arrangement ensures that the locking device has a particularly high strength, in particular in and counter to the transverse direction, because the adapter arrangement completely or at least substantially supports the locking device on either side.

The problem is also solved by a vehicle seat having a seat structure component, in particular a backrest structure, and an adapter arrangement according to the invention for fastening a locking unit according to the invention to the seat structure component. A vehicle seat with a locking device according to the invention has a high strength, in particular in and counter to a transverse direction.

In summary, and expressed in other words, the invention provides a locking unit, comprising a housing and a locking device arranged at least partially in the housing, in the case of which the housing can be manufactured from a material of less high strength (compared to the prior art), in that forces acting laterally on the rotary latch and/or securing elements of the locking device can be dissipated into a seat structure via a direct path.

Such a locking unit may for example be used for detachably locking a foldable backrest structure to a vehicle body. The housing in which the locking device is arranged may be a housing made of a soft material, in particular plastic.

The locking unit may comprise a locking device, and be mounted without a side plate (made of metal and adjacent to the rotary latch) to form a delivery unit, in order to be mounted on an adapter arrangement of a seat structure. Forces acting laterally on the locking device are introduced into the seat structure via the housing and the adapter arrangement, in particular in the form of compressive forces.

The movable parts (rotary latch, securing elements) are laterally supported in each case by a stepped bolt (bearing bolt with at least one axially securing step). As a result, before being mounted into the housing and before being mounted on an adapter arrangement of a seat structure, the locking device is already a functional assembly and deliverable unit, which is only fully capable of bearing loads after being mounted on the adapter arrangement of a seat structure.

A small distance between, on the one hand, the rotary latch and the securing elements and, on the other hand, the adapter arrangement of the seat structure enables direct lateral support and load transmission to the seat structure in the event of loading. Lateral support between, on the one hand, the rotary latch and the securing elements and, on the other hand, the housing can be effected by at least one supporting rib (first projection) of the housing (in particular formed on a first housing part), which can be manufactured from a lightweight material of low strength, for example plastic. Lateral support between, on the one hand, the housing and, on the other hand, the adapter arrangement of the seat structure can be effected by at least one supporting rib (second projection) of the housing (in particular the first housing part).

An unlocking rod (coupling part), which connects an operating element for unlocking the locking device to a securing element of the locking device, in particular a catch element, may be arranged parallel to the rotary latch and the securing elements and/or laterally between the rotary latch and/or the securing elements and the housing (in particular the second housing part).

An end stop for the closing bracket (mating element) may be integrated in the housing. The end stop may be supported by the adapter arrangement made of higher-strength material and reinforced as a result, in order to withstand considerable impacts when the mating element is being inserted into the housing. The end stop may be arranged in long-lasting contact with the adapter arrangement. As an alternative, the end stop may be at a small distance from the adapter arrangement and abut the latter only after elastic deformation.

Optional threads in the bearing bolt for screwing fasteners (in particular screws) into the bearing bolts make it possible to screw the locking device to an adapter part of the adapter arrangement. The screwed connection of the locking device using threads in the bearing bolts can be combined with an additional thin closure plate, which is plugged onto the bearing bolts on their side facing away from the baseplate.

### DESCRIPTION OF THE FIGURES

The invention is explained in more detail below on the basis of an advantageous exemplary embodiment illustrated in the figures. However, the invention is not restricted to these exemplary embodiments. In the figures:

FIG. 1: shows a schematic side view of a vehicle seat according to the invention and a detail of a vehicle body,

FIG. 2: shows an exploded illustration of a locking unit according to the invention and an adapter arrangement according to the invention,

FIG. 3: shows an exploded illustration of the locking unit from FIG. 2,

FIG. 4: shows a corresponding view of the locking unit from FIG. 2,

FIG. 5: shows a section through the locking unit from FIG. 2,

FIG. 6: shows a plan view of a detail of a first housing part of a housing of the locking unit from FIG. 2 and a coupling part of an actuating device of the locking unit from FIG. 2, and

FIG. 7. shows a plan view in transparency of a detail of the locking unit from FIG. 2.

### DETAILED DESCRIPTION

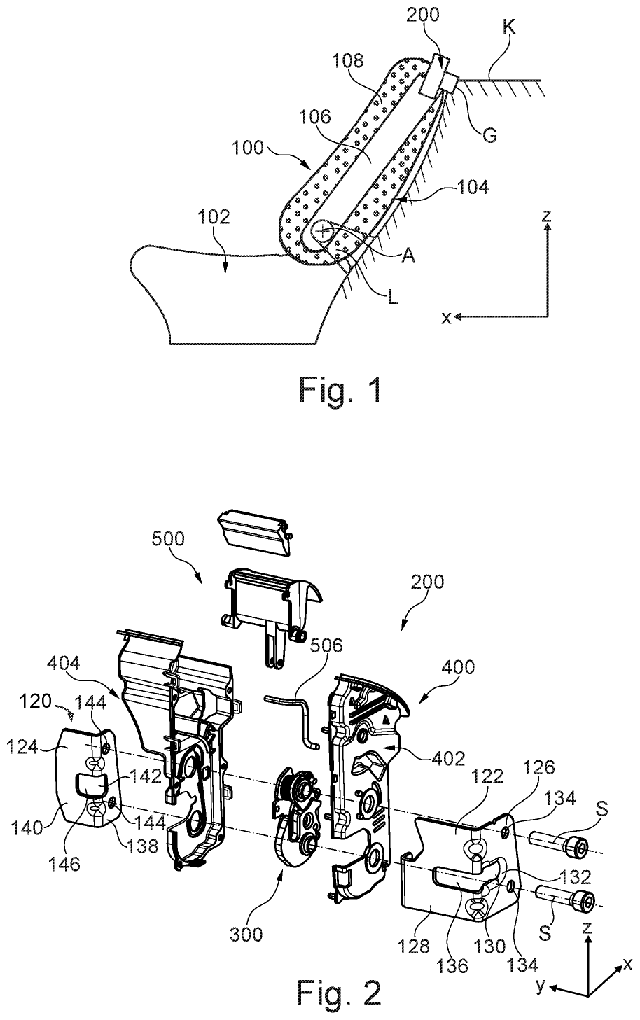

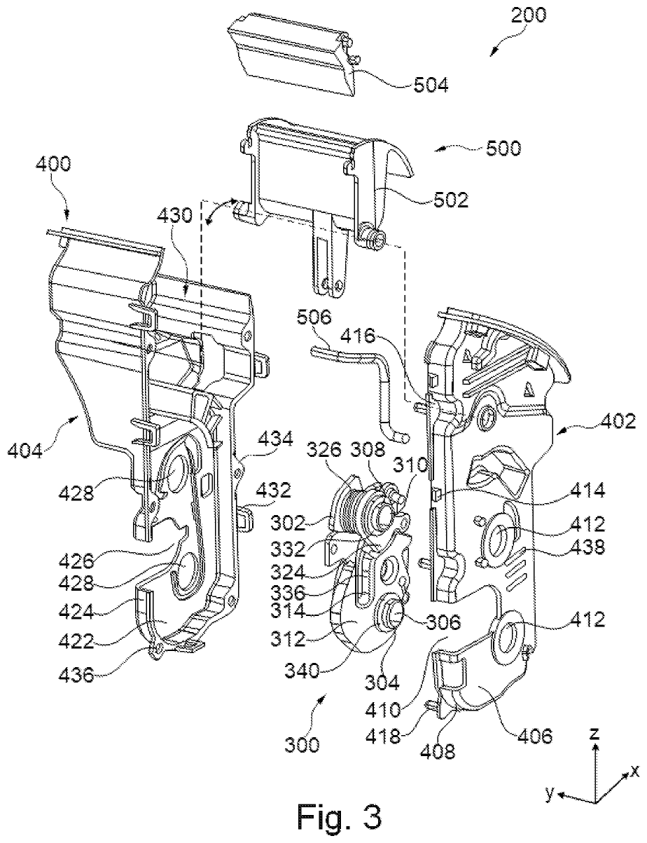

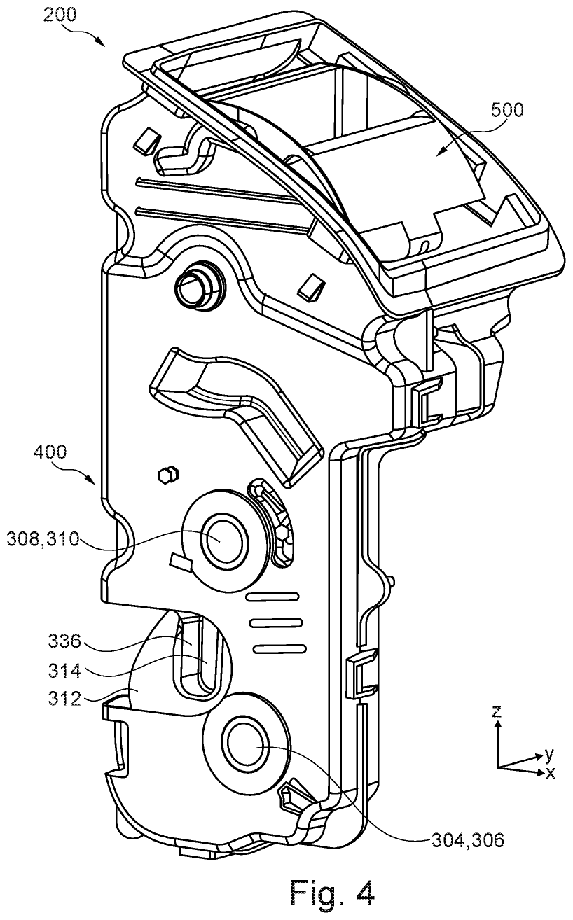

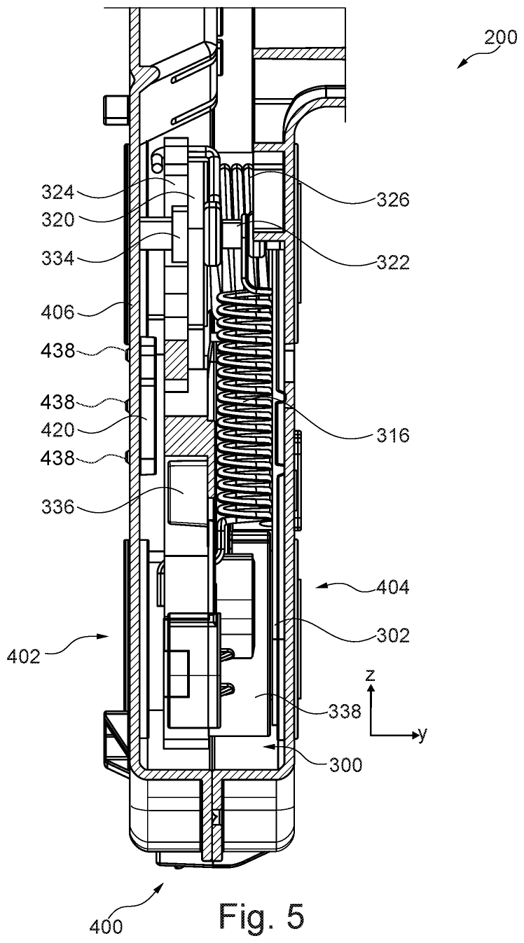

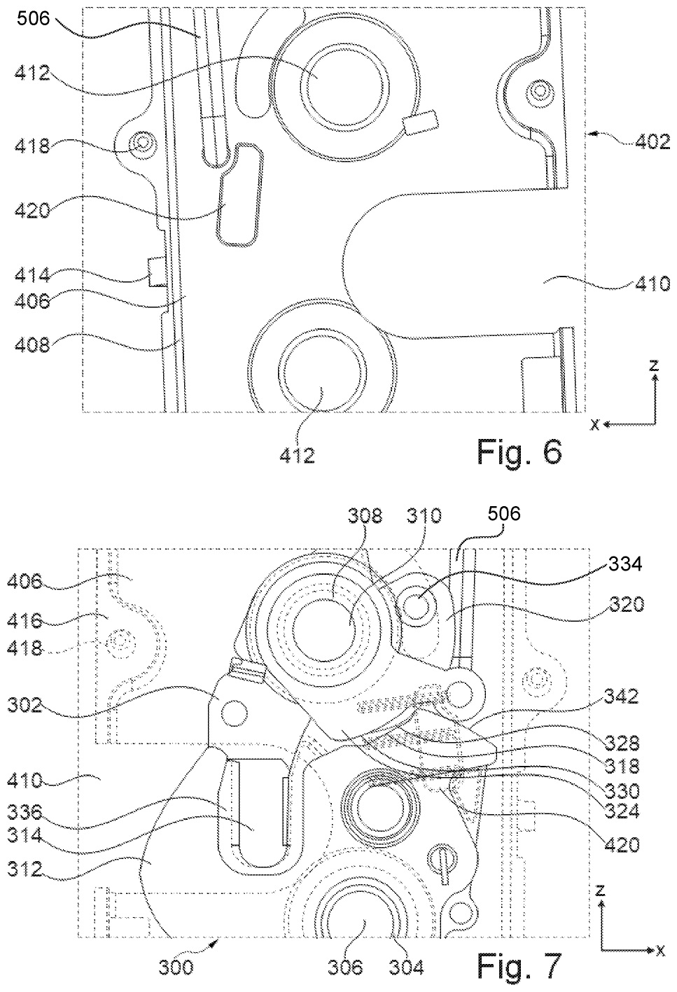

FIG. 1 highly schematically shows a vehicle seat 100 according to the invention, mounted in a vehicle body K of a motor vehicle. The vehicle seat 100 is in the form of a back seat system in the present case. However, the invention can also be applied to other vehicle seats, for example front seats. The vehicle seat 100 comprises a seat part 102 and a backrest 104. The backrest 104 comprises a load-bearing backrest structure 106, for example a tubular frame or a sheet-metal shell. The backrest structure 106 bears a cushion 108.

The vehicle seat 100 will be described below using three spatial directions which extend perpendicularly with respect to one another. In the case of a vehicle seat 100 installed in the vehicle, a longitudinal direction x extends largely horizontally and preferably parallel to a vehicle longitudinal direction, which corresponds to the normal direction of travel of the vehicle. A transverse direction y extending perpendicularly with respect to the longitudinal direction x is likewise oriented horizontally in the vehicle and extends parallel to a vehicle transverse direction. A vertical direction z extends perpendicularly with respect to the longitudinal direction x and perpendicularly with respect to the transverse direction y. In the case of a vehicle seat 100 installed in the vehicle, the vertical direction z extends parallel to the vehicle vertical axis.

The positional and directional indications used, such as front, rear, top and bottom, relate to a viewing direction of an occupant seated in the vehicle seat 100 in a normal seating position, the vehicle seat 100 being installed in the vehicle, in a use position which is suitable for passenger transportation, with an upright backrest 104, and is oriented, as is customary, in the direction of travel. The vehicle seat 100 according to the invention may also be installed, however, in a different orientation, for example transversely to the direction of travel.

The backrest 104 is articulated to the vehicle body K pivotably about a backrest pivot axis A extending parallel to the transverse direction y. To this end, the backrest structure 106 is connected to the vehicle body K on either side by a respective pivot bearing L. The two pivot bearings L are arranged in a lower region of the backrest 104. The axes of rotation of the two pivot bearings L are in line with one another and in the present case extend parallel to the transverse direction y.

A locking unit 200 according to the invention is arranged in an upper region of the backrest 104. The locking unit 200 may for example be arranged on the backrest structure 106 off-centre, that is facing towards a vehicle outer side. The locking unit 200 and thus the backrest 104 are detachably lockable to a mating element G fastened to the vehicle body K. In an unlocked state of the locking unit 200, the backrest 104 can be folded forwards about the backrest pivot axis A onto the seat part 102, in order for example to enlarge a luggage compartment arranged behind the vehicle seat 100. In an upright position of the backrest 104 suitable for passenger transportation, the backrest 104 can be locked to the mating element G and thus to the vehicle body K by the locking unit 200.

FIG. 2 shows an exploded illustration of an adapter arrangement 120 according to the invention and the locking unit 200. The locking unit 200 is fastened to the backrest structure 106 by the adapter arrangement 120. The adapter arrangement 120 is preferably welded to the backrest structure 106. As an alternative, the adapter arrangement 120 may be screwed or riveted to the backrest structure 106.

The adapter arrangement 120 has a first adapter part 122 and a second adapter part 124. The locking unit 200 is arranged between the first adapter part 122 and the second adapter part 124 and is screwed to the adapter arrangement 120 by two screws S, and thus connected fixedly to the backrest structure 106.

A housing 400 of the locking unit 200 is arranged between the first adapter part 122 and the second adapter part 124 in the transverse direction y. The housing 400 is supported in at least one direction, preferably two opposite directions, in the present case in and/or counter to the transverse direction y, by the adapter arrangement 120. The first adapter part 122 and the second adapter part 124 are preferably made from sheet metal, in particular sheet steel. The first adapter part 122 and the second adapter part 124 reinforce the housing 400 of the locking unit 200. This considerably increases the load-bearing capacity of the locking unit 200, in particular in the transverse direction y.

The first adapter part 122 is a metal sheet which has been bent once. The first adapter part 122 is L-shaped. The first adapter part 122 has a first leg 126 and a second leg 128. The first leg 126 is largely planar. The first leg 126 preferably extends perpendicularly with respect to the transverse direction y. The first leg 126 has a slot 130, which makes it possible to insert the mating element G into the adapter arrangement 120 in order to interact with a rotary latch 312. The slot 130 is preferably dimensioned such that the mating element G is supported by the first adapter part 122 when the mating element G for locking to the rotary latch 312 is inserted in the slot 130. A bent-over portion 132 in the peripheral region of the slot 130 has the effect of a lower surface pressure in the region of the contact point between the first adapter part 122 and the mating element G.

The first adapter part 122 has two through-holes 134 for screws S. In the present case, the through-holes 134 are in the first leg 126 of the first adapter part 122. The two through-holes 134 are in line with through-openings 306, 310 in bearing bolts 304, 308 of the locking device 300.

The second leg 128 of the first adapter part 122 preferably extends perpendicularly with respect to the first leg 126 of the first adapter part 122. The second leg 128 is largely planar. An aperture 136 in the second leg 128 expands the slot 130 into the second leg 128 and makes it possible to insert the mating element G. The aperture 136 is correspondingly adapted to a width of the mating element G.

The second adapter part 124 is a metal sheet which has been bent once. The second adapter part 124 is L-shaped. The second adapter part 124 has a first leg 138 and a second leg 140. The first leg 138 is largely planar. The first leg 138 preferably extends perpendicularly with respect to the transverse direction y. The first leg 138 of the second adapter part 124 has a slot 142, which makes it possible to insert the mating element G into the adapter arrangement 120 in order to interact with the rotary latch 312. The slot 312 thus has the same function as the slot 130 in the first adapter part 122. The slot 142 is preferably dimensioned such that the mating element G is supported by the second adapter part 124 when the mating element G for locking by the rotary latch 312 is inserted in the slot 142.

The first leg 138 of the second adapter part 124 is preferably parallel to the first leg 126 of the first adapter part 122. The first leg 138 of the second adapter part 124 is spaced from the first leg 126 of the first adapter part 122. A gap between the two first legs 126, 138 can serve for positioning the adapter arrangement 120 on the backrest structure 106 and form-fittingly fixing it in at least one spatial direction, for example a tube of the backrest structure 106 can be arranged in the gap between the two first legs 126, 138. The first adapter part 122 and/or the second adapter part 124 are preferably welded to the backrest structure 106.

The second adapter part 124 has two through-holes 144 for screws S. Moreover, two threaded nuts, in particular welded nuts, which are in line with the through-holes 144 and into which the screws S can be screwed may be fastened to the second adapter part 124. In the present case, the through-holes 144 are made in the first leg 138 of the second adapter part 124. The two through-holes 144 are in line with the through-openings 306, 310 in the bearing bolts 304, 308 and the through-holes 124 in the first adapter part 122.

The second leg 140 of the second adapter part 124 is preferably perpendicular to the first leg 138 of the second adapter part 124. The second leg 140 is largely planar. An aperture 146 in the second leg 140 expands the slot 142 into the second leg 140 and makes it possible to insert the mating element G. The aperture 146 is correspondingly adapted to a width of the mating element G.

The adapter arrangement 120 avoids buckling of the rotary latch 312, a bracing element 320 and a catch element 324 in the event of forces acting on the rotary latch 312 via the mating element G in the transverse direction y in that the adapter arrangement 120 supports the housing 400 via a second projection 438, which in the present case is formed of three supporting ribs, and the housing 400 supports the rotary latch 312, the bracing element 320 and the catch element 324, in particular via a first projection 420.

The locking unit 200 has a locking device 300, a housing 400 and an actuating device 500 for unlocking the locking device 300.

The locking device 300 is a refinement according to the invention of a rotary latch lock known from the prior art, for example from WO 2016/079041 A1, the disclosure of which regarding the basic structure of such a locking device is expressly incorporated, unless described otherwise below. The mating element G may be a bolt or wire bracket fixedly connected to the vehicle body K.

The locking device 300 has exactly one baseplate 302, which in the present case consists of metal and has a flat form. The baseplate 302 forms a base, on which essential components of the locking device 300 are arranged and to which some of them are fastened or articulated. The baseplate 302 has an elongate form and has a first opening for receiving a first bearing bolt 304 and a second opening for receiving a second bearing bolt 308. The first bearing bolt 304 is arranged at a spacing from the second bearing bolt 308.

The terms “axially”, “radially” and “circumferential direction” used below in connection with the locking device 300 each relate to the longitudinal extent of the first bearing bolt 304 or the second bearing bolt 308. In a state of the locking device 300 mounted on a vehicle seat 100, the bearing bolts 304, 308 preferably each extend parallel to the transverse direction y, with the result that the respective axial directions also extend parallel to the transverse direction y.

The first bearing bolt 304 is in the form of a stepped bolt in the present case. The first bearing bolt 304 is plugged in the first opening in the baseplate 302 as far as a step of the first bearing bolt 304 and connected, preferably riveted, thereto. The first bearing bolt 304 has a through-opening 306 with an approximately constant inside diameter.

The second bearing bolt 308 is in the form of a stepped bolt in the present case. The second bearing bolt 308 is plugged in the first opening in the baseplate 302 as far as a step of the second bearing bolt 308 and connected, preferably riveted, thereto. The second bearing bolt 308 has a through-opening 310 with an approximately constant inside diameter.

The through-openings 306, 310 in the bearing bolts 304, 308 serve for receiving a respective fastener, in the present case a respective screw S, which can be used to fasten the locking unit 200 to the backrest 104 during the mounting.

A rotary latch 312 is pivotably mounted on the first bearing bolt 304. The rotary latch 312 has a slot-shaped receptacle 314 for interacting with the mating element G. In a locked state of the locking unit 200, the rotary latch 312 has been pivoted into a closed position and the mating element G is arranged at least partially in the receptacle 314, wherein the receptacle 314 of the rotary latch 312 in its closed position extends such that the mating element G is form-fittingly secured and cannot leave the receptacle 314. The rotary latch 312 is preloaded in the direction of an open position by a spring, referred to as first spring 316 below. In the unlocked state of the locking unit 200, the rotary latch 312 is pivotable in its open position. In the open position of the rotary latch 312, the receptacle 314 extends such that the mating element G can leave the receptacle 314.

The rotary latch 312 has a supporting contour 318. The supporting contour 318 has an approximately planar form but may, for example, also be curved in the form of a circular arc and have a concave form. In the locked state of the locking device 300, the supporting contour 318 points approximately in the direction of the second bearing bolt 308, which extends parallel to the first bearing bolt 304.

A bracing element 320 is pivotably mounted on the second bearing bolt 308. The bracing element 320 is preloaded towards the rotary latch 312 by a first spring 316. In the present case, the first spring 316 is in the form of a tension spring, the first spring end of which is hooked in the rotary latch 312 and the second spring end of which is hooked on the bracing element 320, in the present case on a peg 322 of the bracing element 320.

Moreover, a catch element 324 is arranged on the second bearing bolt 308 axially next to the bracing element 320 and likewise pivotably mounted on the second bearing bolt 308. The catch element 324 is preloaded towards the rotary latch 312 by a further spring, referred to as second spring 326 below.

The bracing element 320 and the catch element 324 are securing elements which secure the rotary latch 312 in its closed position. In the locked state of the locking device 300, when the receptacle 314 of the rotary latch 312 secures the mating element G, the bracing element 320 exerts a closing moment on the rotary latch 312 on account of the preloading by the second spring 326. To this end, the bracing element 320 has a bracing surface 328, which is eccentrically curved in relation to the second bearing bolt 308 and is in non-self-locking contact with the supporting contour 318 of the rotary latch 312. The bracing surface 328 is curved in the form of a circular arc and has a convex form in the present case.

The catch element 324 is arranged on the second bearing bolt 308 axially next to the bracing element 320 and likewise pivotably mounted on the second bearing bolt 308. The bracing element 324 is preloaded towards the rotary latch 312 by a first spring 316.

The catch element 324 has a catching surface 330. In the locked state of the locking device 300, the catching surface 330 is spaced from the supporting contour 318 of the rotary latch 312. The catching surface 330 is curved in the form of a circular arc and has a convex form in the present case, but can also be planar.

The catch element 324 in the present case is arranged on a side of the bracing element 320 that faces away from the baseplate 302. The second spring 326 is in the form of a leg spring in the present case. A first spring end of the second spring 326 is supported on the baseplate 302. A second spring end of the second spring 326 is supported on the catch element 324. The second spring 326 is arranged between the baseplate 302 and the bracing element 320 on the second bearing bolt 308. The bracing element 320 is pivotably mounted on the second bearing bolt 308 between the second spring 326 and the catch element 324. The catch element 324 is mounted on the second bearing bolt 308 between the bracing element 320 and an axial securing device 332 of the second bearing bolt 308. In the present case, the axial securing device 332 is an encircling step of the second bearing bolt 308, the step having a greater diameter than a bearing opening in the catch element 324 through which the second bearing bolt 308 is plugged.

The catch element 324 and the bracing element 320 are coupled in terms of drive in the circumferential direction of the second bearing bolt 308, possibly by traversing an idle travel in the circumferential direction, in the present case by a driver bolt 334 which protrudes axially from the bracing element 320.

The peripheral regions of the receptacle 314 in the rotary latch 312 are at least partially covered by a sheath 336, which in the present case consists of plastic. The sheath 336 substantially covers those portions of the receptacle 314 that can come into contact with the mating element G. In the region of the first bearing bolt 304, the sheath 336 has an approximately cylindrical spacer disc 338, which has an opening through which the first bearing bolt 304 is plugged.

The spacer disc 338 of the sheath 336 is arranged between the baseplate 302 and the rotary latch 312. The rotary latch 312 is mounted on the first bearing bolt 304 between the spacer disc 338 and an axial securing device 340 of the first bearing bolt 304. In the present case, the axial securing device 340 is an encircling step of the first bearing bolt 304, the step having a greater diameter than a bearing opening in the rotary latch 312 through which the first bearing bolt 304 is plugged.

To unlock the locking device 300, the catch element 324 can be pivoted away from the rotary latch 312, as a result of which the catching surface 330 of the catch element 324 moves further away from the supporting contour 318 of the rotary latch 312. After traversing the idle travel, the catch element 324 conjointly rotates the bracing element 320 far enough that the rotary latch 312 is no longer secured by the bracing element 320 and the catch element 324 and can be pivoted in the direction of the open position of the rotary latch 312, in particular assisted by the preloaded first spring 316. In the open position of the rotary latch 312, the receptacle 314 releases the mating element G, with the result that the backrest 104 can be pivoted forwards about the backrest pivot axis A.

If the mating element G has left the receptacle 314, the locking device 300 is thus also in the unlocked state. A hold-open contour 342 provided on the rotary latch 312 locks the catch element 324 and the bracing element 320 in their unlocked position.

If the mating element G re-enters the receptacle 314 in the rotary latch 312 in this unlocked state of the locking device 300, the mating element G presses the rotary latch 312 into the position that locks the mating element G. The bracing element 320 moves along the supporting contour 318 on account of its preloading by the second spring 326. The catch element 324, which is now no longer locked by the hold-open contour 342, pivots towards the rotary latch 312, whether taken along by the bracing element 320 and/or on account of the preloading by the second spring 326, wherein the catching surface 330 moves closer to the supporting contour 318 of the rotary latch 312. As a result, the locking device 300 is in the locked state again.

The locking device 300 is largely completely arranged in the housing 400. The housing 400 has a first housing part 402 and a second housing part 404, which between them form a cavity for receiving the locking device 300. The two housing parts 402, 404 are connected to one another.

The first housing part 402 has a bottom 406. The bottom 406 is approximately planar and preferably perpendicular to the axial direction. A side wall 408 protrudes in the direction of the second housing part 404 in the outer peripheral region of the bottom 406. Preferably, the side wall 408 runs peripherally around the bottom 406 and is perpendicular to the bottom 406 of the first housing part 402. The bottom 406 and the side wall 408 have a cutout 410 which makes it possible to insert the mating element G into the cavity in the housing 400, in order to interact with the rotary latch 312 there, as described above. The bottom 406 also has two bolt receptacles 412 that are in line with the bearing bolts 304, 308 of the locking device 300. The first housing part 402 is plugged on the bearing bolts 304, 308, with the result that the bearing bolts 304, 308 are plugged in the bolt receptacles 412, preferably as far as the axial securing devices 332, 340.

The side wall 408 has multiple latching lugs 414 distributed around the periphery. An end region, facing away from the bottom 406, of the side wall 408 has a flange 416. The flange 416 is preferably formed on the side wall 408 perpendicularly with respect to the axial direction and thus parallel to the bottom 406. Multiple centring devices 418, in the present case centring mandrels, project from the flange 416 in the direction of the second housing part 404.

The bottom 406 of the first housing part 402 has a first projection 420, which is formed in the direction of the rotary latch 312 and the securing element (bracing element 320, catch element 324). The first projection 420 has the smallest spacing of the bottom 406 of the first housing part 402 from the rotary latch 312 in the axial direction, in the present case in the transverse direction y. In other words, the first projection 420 is that region of the bottom 406 that has the smallest axial spacing from the rotary latch 312. Moreover, the first projection 420 has the smallest spacing of the bottom 406 of the first housing part 402 from the catch element 324 in the axial direction, in the present case in the transverse direction y. In other words, the first projection 420 is that region of the bottom 406 that has the smallest axial spacing from the catch element 324. If high, in particular lateral forces act on the rotary latch 312 and/or the catch element 324, the first projection 420 serves to laterally support the rotary latch 312 and/or the catch element 324 on the housing 400.

The bottom 406 of the first housing part 402 also has a second projection 438, which in the present case is formed of three supporting ribs. The second projection 438 is formed on the bottom 406 in an opposite direction to the first projection 420. The second projection 438 abuts the first adapter part 122 of the adapter arrangement 120, in the present case its first leg 126. If high, in particular lateral forces act on the rotary latch 312 and/or the catch element 324, the second projection 438 serves to laterally support the housing 400 on the adapter arrangement 120. As a result, the housing 400 can be made from a plastic.

Owing to the above-described geometry of the first housing part 402, the first housing part 402 has a largely half-shell-like form.

The second housing part 404 has a bottom 422. The bottom 422 is approximately planar and preferably perpendicular to the axial direction. A side wall 424 protrudes in the direction of the first housing part 402 in the outer peripheral region of the bottom 422. Preferably, the side wall 424 runs peripherally around the bottom 422 and is perpendicular to the bottom 422 of the second housing part 404. The bottom 422 and the side wall 424 have a cutout 426 which makes it possible to insert the mating element G into the cavity in the housing 400 and the slots 130, 142 in the adapter arrangement 120, in order to interact with the rotary latch 312 there, as described above. The bottom 422 also has two bolt receptacles 428 that are in line with the bearing bolts 304, 308 of the locking device 300. The second housing part 404 is plugged on the bearing bolts 304, 308 and therefore the bearing bolts 304, 308 are plugged in the bolt receptacles 428, with the result that the baseplate 302 preferably abuts the bottom 422.

The bottom 422 of the second housing part 404 also has a recess 430 for receiving an actuating device 500. The actuating device 500 has an operating element 502, in the present case an unlocking handle, and an indicator 504. The operating element 502 is pivotably mounted in the housing 400 as is known per se. The indicator 504 is pivotably mounted on the operating element 502 and indicates the pivoting position of the operating element 502 and thus the locking state of the locking element 300, as is known per se.

The operating element 502 is operatively connected to the catch element 324 of the locking device 300 by a coupling part 506, in the present case a wire which is bent multiple times. Pivoting the operating element 502 makes it possible to pivot the catch element 324 and, by way of the latter, the bracing element 320 via the coupling part 506, with the result that the locking device 300 can be unlocked in the way described above. The coupling part 506 is preferably guided between, on the one hand, the first housing part 402 and, on the other hand, the rotary latch 312 and/or the securing elements 320, 324 in such a way that the coupling part 506 can transmit high laterally acting forces from the rotary latch 312 and/or the securing elements 320, 324 to the housing 400.

The side wall 424 of the second housing part 404 has multiple latching devices 432 distributed around the periphery for form-fittingly interacting with the latching lugs 414 of the first housing part 402. The latching devices 432 and the latching lugs 414 together form clip connections for fastening the housing parts 402, 404 to one another.

An end region, facing away from the bottom 422, of the side wall 424 has a flange 434. The flange 434 is preferably formed on the side wall 424 perpendicularly with respect to the axial direction and thus parallel to the bottom 422. Multiple centring openings 436 for receiving the centring devices 418 of the first housing part 402 are made in the flange 434. In a mounted state of the housing 400, the flange 434 of the second housing part 404 abuts the flange 416 of the first housing part 402.

Owing to the above-described geometry of the second housing part 404, the second housing part 404 has a largely half-shell-like form.

The features which are disclosed in the above description, in the claims and in the figures can be of significance both individually and in combination for the implementation of the invention in its various embodiments, provided that they remain within the scope of protection of the claims.

### LIST OF REFERENCE SIGNS

100 Vehicle seat
102 Seat part
104 Backrest
106 Backrest structure
108 Cushion
120 Adapter arrangement
122 First adapter part
124 Second adapter part
126 First leg
128 Second leg
130 Slot
132 Bent-over portion
134 Through-hole
136 Aperture
138 First leg
140 Second leg
142 Slot
144 Through-hole
146 Aperture
200 Locking unit
300 Locking device
302 Baseplate
304 First bearing bolt
306 Through-opening
308 Second bearing bolt
310 Through-opening
312 Rotary latch
314 Receptacle
316 First spring
318 Supporting contour
320 Securing element, bracing element
322 Peg
324 Securing element, catch element
326 Second spring
328 Bracing surface
330 Catching surface
332 Axial securing device
334 Driver bolt
336 Sheath
338 Spacer disc
340 Axial securing device
342 Hold-open contour
400 Housing
402 First housing part
404 Second housing part
406 Bottom
408 Side wall
410 Cutout
412 Bolt receptacle
414 Latching lug
416 Flange
418 Centring device
420 First projection
422 Bottom
424 Side wall
426 Cutout
428 Bolt receptacles
430 Recess
432 Latching device
434 Flange
436 Centring opening
438 Second projection
500 Actuating device
502 Operating element
504 Indicator
506 Coupling part
A Backrest pivot axis
G Mating element
K Vehicle body
L Pivot bearing
S Screw
x Longitudinal direction
y Transverse direction
Z Vertical direction

1-10. (canceled)

11. A locking unit for a vehicle seat, comprising:
a housing and a locking device, arranged at least partially in the housing, for detachably locking a mating element, the locking device, comprising:
a) a baseplate;
b) a first bearing bolt having exactly one end region fixedly connected to the baseplate;
c) a second bearing bolt having exactly one end region of the second bearing bolt fixedly connected to the baseplate;
d) a rotary latch with a receptacle for securing the mating element, wherein the rotary latch is pivotably mounted on the first bearing bolt;
e) at least one securing element for securing a closed position of the rotary latch, wherein the at least one securing element is pivotably mounted on the second bearing bolt,
the housing, comprising:
f) a first housing part with a bottom, and
g) a second housing part with a bottom,
wherein the locking device is arranged axially between the bottom of the first housing part and the bottom of the second housing part,
the rotary latch and the at least one securing element are arranged axially between the baseplate and the bottom of the first housing part, and
the bottom of the first housing part has at least one projection, which is formed in the direction of the rotary latch and/or the at least one securing element.

12. The locking unit according to claim 11, wherein a smallest distance between the projection of the first housing part and the rotary latch corresponds to
a smallest distance between the first housing part and the rotary latch; and/or
a smallest distance between the projection of the first housing part and the at least one securing element corresponds to a smallest distance between the first housing part and the at least one securing element.

13. The locking unit according to claim 11, wherein the first bearing bolt has an axial securing device for axially securing the rotary latch on the first bearing bolt in at least one axial direction, wherein the bottom of the first housing part
directly abuts the axial securing device of the first bearing bolt; and/or
the second bearing bolt has an axial securing device for axially securing the at least one securing element on the second bearing bolt in at least one axial direction, wherein the bottom of the first housing part directly abuts the axial securing device.

14. The locking unit according to claim 11, wherein the locking unit has an actuating device for unlocking the locking device, the actuating device having an operating element and a coupling part comprising a wire for coupling the operating element to the at least one securing element of the locking device.

15. The locking unit according to claim 14, wherein the coupling part is at least partially arranged between, on the one hand, the rotary latch and/or the at least one securing element and, on the other hand, the bottom of the first housing part.

16. The locking unit according to claim 11, wherein the bottom of the first housing part has at least one further projection which is formed on a side of the bottom of the first housing part that faces away from the rotary latch.

17. The locking unit (200) according to claim 11, wherein an end stop for the mating element is integrated in the housing.

18. The locking element according to claim 11, wherein the first bearing bolt is connected to the second bearing bolt by a closure plate, wherein the closure plate is arranged axially between the rotary latch and the first housing part.

19. An adapter arrangement for attachment of the locking unit according to claim 11 to a vehicle seat, the adapter arrangement comprising a first adapter part and a second adapter part, between which the locking device can be arranged and laterally supported.

20. A vehicle seat having a backrest structure, and an adapter arrangement for fastening the locking unit according to claim 11 to the backrest structure, wherein the adaptor arrangement comprises a first adapter part and a second adapter part, between which the locking device can be arranged and laterally supported.
